(19) United States
(12) Patent Application Publication
(10) Pub. No.: US 2025/0233164 A1
(43) Pub. Date: Jul. 17, 2025

(54) AIR ELECTRODE COMPOSITES, METHODS OF MANUFACTURING THE SAME, AND ELECTROCHEMICAL CELL INCLUDING THE SAME

(71) Applicant: Korea Institute of Science and Technology, Seoul (KR)

(72) Inventors: Kyung Joong YOON, Seoul (KR); Hye Jung Chang, Seoul (KR); Mi Young Park, Seoul (KR); Sun-Young Park, Seoul (KR); Ha Neul Choi, Seoul (KR)

(21) Appl. No.: 18/617,265

(22) Filed: Mar. 26, 2024

(30) Foreign Application Priority Data
Jan. 17, 2024 (KR) 10-2024-0007098

(51) Int. Cl. H01M 4/90; H01M 4/86; H01M 4/88; H01M 8/12

(52) U.S. Cl. CPC H01M 4/9025; H01M 4/8605; H01M 4/8673; H01M 4/8885; H01M 8/12; H01M 2008/1293

(57) ABSTRACT

Provided are an air electrode composite, a method of manufacturing the same, and an electrochemical cell including the same. Specifically, an air electrode composite in which electron conductive nanoparticles are uniformly distributed on the surface of an oxygen ion conductive porous structure, a method of manufacturing the same, and an electrochemical cell including the same are provided.

### CROSS-REFERENCE TO RELATED APPLICATION

This application claims priority to and the benefit of Korean Patent Application No. 10-2024-0007098 filed in the Korean Intellectual Property Office on Jan. 17, 2024, the entire contents of which are incorporated herein by reference.

### BACKGROUND OF THE INVENTION

### (a) Field of the Invention

The present disclosure relates to an air electrode composite, a method of manufacturing the same, and an electrochemical cell including the same. In particular, the present disclosure relates to an air electrode composite in which electron conductive nanoparticles are uniformly distributed on a surface of an oxygen ion conductive porous structure, a method of manufacturing the same, and an electrochemical cell including the same.

### (b) Description of the Related Art

In an electrode of an electrochemical cell such as a solid oxide fuel cell and a water electrolysis cell, electron and oxygen ion flows should be secured simultaneously. Thus, conventionally, a composite manufactured by mixing powders of an electron conductive material and an oxygen ion conductive material has been applied as an electrode. Further, the two materials are generally mixed at a ratio of 50:50 so as to have connectivity to each other.

However, when conductivities of the electron conductive material and the oxygen ion conductive material are compared, the electron conductive material has a conductivity of about 100 S/cm or more and the oxygen ion conductive material has a conductivity of 0.1 S/cm or less. Therefore, performance of a composite electrode in which the two materials are mixed at the same ratio may be limited by the oxygen ion conductive material having significantly low conductivity. In addition, in order to extend an oxygen ion conduction path, an attempt was made to increase the ratio of the oxygen ion conductive material, but connectivity of the electron conductive material is lost, and the electrode cannot normally operated.

In order to solve the above problems, an electrode composite in which the electron conductive material and the oxygen ion conductive material are mixed at an optimal ratio and connectivity between the materials is improved, and a method of manufacturing the same are needed.

### SUMMARY OF THE INVENTION

The present disclosure attempts to provide an air electrode composite having both improved oxygen ion conductive and electron conductivity by uniformly applying electron conductive nanoparticles on a surface of an oxygen ion conductive porous structure.

The present disclosure also attempts to provide a method of manufacturing an air electrode composite having the merits described above.

The present disclosure also attempts to provide an electrochemical cell to which the air electrode composite having the merits described above is applied.

An exemplary embodiment of the present disclosure provides an air electrode composite including: a porous structure including an oxygen ion conductive material; and electron conductive nanoparticles which are distributed in an island shape on a surface of the porous structure, wherein the electron conductive nanoparticles have an average particle diameter (D50) of 5 to 50 nm. Specifically, the electron conductive nanoparticles may have the average particle diameter (D50) of 5 to 40 nm, 7 to 35 nm, 10 to 30 nm, 10 to 25 nm, or 10 to 20 nm.

Another exemplary embodiment of the present disclosure provides a method of manufacturing an air electrode composite including: forming a porous structure including an oxygen ion conductive material; preparing a precursor solution in which an electron conductive material precursor, urea, and glycine are mixed; injecting the precursor solution into pores of the porous structure; and heat treating the porous structure into which the precursor solution has been injected, wherein in the heat treating, a heat treatment temperature is in range of 600 to 900° C.

Still another exemplary embodiment of the present disclosure provides an electrochemical cell including the air electrode composite according to an exemplary embodiment of the present disclosure.

The electrochemical cell according to another exemplary embodiment of the present disclosure may be any one of a solid oxide fuel cell or a water electrolysis cell.

The air electrode composite according to an exemplary embodiment of the present disclosure may secure both oxygen ion conductivity and electron conductivity to improve performance of the electrochemical cell.

The method of manufacturing an air electrode composite according to another exemplary embodiment of the present disclosure may provide the air electrode composite having the merits described above.

The electrochemical cell according to another exemplary embodiment of the present disclosure may include the air electrode composite having the merits described above to improve electrochemical performance.

### BRIEF DESCRIPTION OF THE DRAWINGS

FIG. 1 is a conceptual diagram of an air electrode composite according to an exemplary embodiment of the present disclosure.

FIG. 2 is an SEM image of an air electrode composite manufactured according to Example 1 of the present disclosure.

FIG. 3 is a TEM image of the air electrode composite manufactured according to Example 1 of the present disclosure.

FIG. 4 is an SEM image of an air electrode composite manufactured according to Example 2 of the present disclosure.

FIG. 5 is an SEM image of an air electrode composite manufactured according to Example 1 of the present disclosure.

FIG. 6 is an impedance measurement result graph of an air electrode composite manufactured according to Comparative Example 1 of the present disclosure.

FIG. 7 is an impedance measurement result graph of the air electrode composite manufactured according to Example 1 of the present disclosure.

FIG. 8 is an impedance measurement result graph of the air electrode composite depending on injection amounts of electron conductive nanoparticles.

FIG. 9 is an output characteristic evaluation result graph of solid oxide fuel cells manufactured according to Example 1 and Comparative Example 1.

FIG. 10 is a lifespan characteristic evaluation result graph of the solid oxide fuel cells manufactured according to Example 1.

FIG. 11 shows output characteristic evaluation results of a button cell (1 cm²) and a large area cell (100 cm²) manufactured according to Example 1.

FIG. 12 shows a schematic diagram of the air electrode composite of the present disclosure.

### DETAILED DESCRIPTION OF THE EMBODIMENTS

The terms such as first, second, and third are used for describing various parts, components, areas, layers, and/or sections, but are not limited thereto. These terms are used only for distinguishing one part, component, area, layer, or section from other parts, components, areas, layers, or sections. Therefore, a first part, component, area, layer, or section described below may be mentioned as a second part, component, area, layer, or section without departing from the scope of the present disclosure.

The terminology used herein is only for mentioning a certain example, and is not intended to limit the present disclosure. Singular forms used herein also include plural forms unless otherwise stated clearly to the contrary. The meaning of “comprising” used in the specification is embodying certain characteristics, areas, integers, steps, operations, elements, and/or components, but is not excluding the presence or addition of other characteristics, areas, integers, steps, operations, elements, and/or components.

When it is mentioned that a part is “on” or “above” the other part, it means that the part is directly on or above the other part or another part may be interposed therebetween. In contrast, when it is mentioned that a part is “directly on” the other part, it means that nothing is interposed therebetween.

Though not defined otherwise, all terms including technical terms and scientific terms used herein have the same meaning as commonly understood by a person with ordinary skill in the art to which the present disclosure pertains. Terms defined in commonly used dictionaries are further interpreted as having a meaning consistent with the related technical literatures and the currently disclosed description, and unless otherwise defined, they are not interpreted as having an ideal or very formal meaning.

In addition, unless particularly mentioned, % refers to wt %, and 1 ppm is 0.0001 wt %.

In the present specification, the term “combination(s) thereof” described in the Markush format refers to a mixture or combination of one or more selected from the group consisting of the constituent elements described in the Markush format, and refers to inclusion of one or more selected from the group consisting of the constituent elements.

Hereinafter, an exemplary embodiment of the present disclosure will be described in detail so that a person with ordinary skill in the art to which the present disclosure pertains may easily carry out the disclosure. As those skilled in the art would realize, the described embodiments may be modified in various different ways, all without departing from the spirit or scope of the present disclosure.

Hereinafter, an air electrode composite according to an exemplary embodiment of the present disclosure will be described.

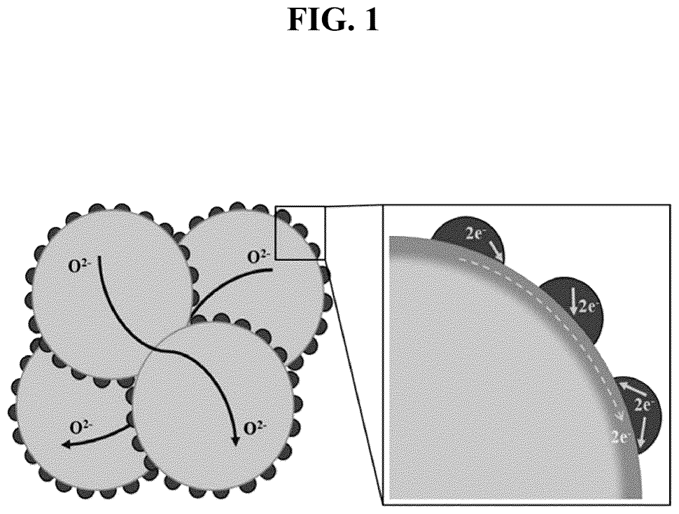

FIG. 1 is a conceptual diagram of the air electrode composite according to an exemplary embodiment of the present disclosure.

Referring to FIG. 1, the air electrode composite according to an exemplary embodiment includes: a porous structure including an oxygen ion conductive material; and electron conductive nanoparticles which are distributed in an island shape on a surface of the porous structure, wherein the electron conductive nanoparticles have an average particle diameter (D50) of 5 to 50 nm. Specifically, the electron conductive nanoparticles may have the average particle diameter (D50) of 5 to 40 nm, 7 to 35 nm, 10 to 30 nm, 10 to 25 nm, or 10 to 20 nm.

In the present disclosure, the oxygen ion conductive material included in the porous structure may be in a particle form. In addition, the porous structure including the oxygen ion conductive material is formed by connecting and binding the oxygen ion conductive material in a particle form, includes the oxygen ion conductive material particles and pores, and shows a shape similar to sponge tissue.

In the present disclosure, the average particle diameter (D50) of the electron conductive nanoparticles refers to an average value of a cross-sectional diameter of the electron conductive nanoparticles observed in an SEM image. The average value of the cross-sectional diameter is an average of the cross-sectional diameters of 10 to 30 electron conductive nanoparticles observed in the SEM image. Specifically, the cross-section refers to an attached surface of the electron conductive nanoparticle attached on the surface of the porous structure. In addition, a diameter of the attached surface is referred to as a cross-sectional diameter of the electron conductive nanoparticle. Further, a cross-sectional diameter of the electron conductive nanoparticle is determined by calculating an average value of a longest diameter (major axis) and a shortest diameter (minor axis) confirmed in the cross-section of the electron conductive nanoparticle.

When the average particle diameter (D50) of the electron conductive nanoparticles is included in the range described above, a uniform electron conduction path is formed to maintain electron conductivity constant and improve electrode performance. However, when the average particle diameter (D50) of the electron conductive nanoparticles is less than the lower limit of the range described above, an overlapping degree of the electron conductive area is decreased, so that a part of the electron conduction path has discontinuity. Thus, electron conductivity may be decreased to deteriorate electrode performance. In addition, the average particle diameter (D50) of the electron conductive nanoparticles is more than the upper limit of the range described above, the electron conductive nanoparticles may be agglomerated or distributed non-uniformly, and rather, polarization resistance or ohmic resistance may be increased to promote deterioration of cells.

In addition, when the electron conductive nanoparticles are uniformly distributed in an island shape, in comparison with the case of forming the electron conductive material as a coat, electron conductivity is in a similar level, but oxygen ion conductivity may be further improved. Besides, even when the electron conductive material is less introduced, a similar electron conductivity effect may be obtained, and thus, there may be economic feasibility.

In the air electrode composite according to an exemplary embodiment, an average separation distance between the electron conductive nanoparticles may be 5 to 50 nm. Specifically, it may be 5 to 45 nm, 6 to 40 nm, 7 to 35 nm, 8 to 30 nm, 9 to 25 nm, 10 to 20 nm, or 10 to 15 nm.

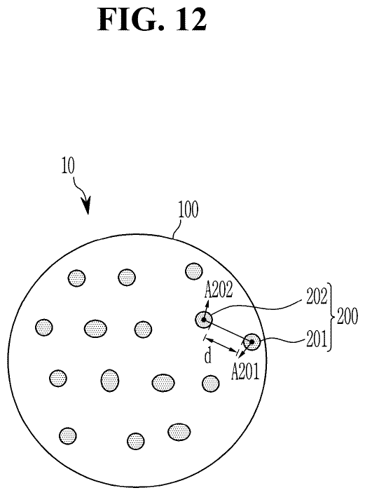

In the present disclosure, the average separation distance between the electron conductive nanoparticles represents the shortest distance between borders of nanoparticle sections, on a line connecting each center of two adjacent nanoparticles. Referring to FIG. 12, what is expressed as d on a line connecting a center A201 of a nanoparticle 201 and a center 202 of another nanoparticle 202 is referred to as the average separation distance between the electron conductive nanoparticles.

When the average separation distance between the electron conductive nanoparticles is included in the range described above, oxygen ion conductivity remains sufficiently high while improving electron conductivity, and thus, performance of an electrode may be improved by significantly lowering resistance of the electrode. However, when the average separation distance between the electron conductive nanoparticles is less than the lower limit of the range described above, agglomeration between the electron conductive nanoparticles may occur and gas transport may be inhibited. In addition, when the average separation distance between the electron conductive nanoparticles is more than the upper limit of the range described above, electron conductive area overlap does not sufficiently occur, and thus, discontinuity of an electron conduction path may occur. Thus, since electron movement is not smooth, electrode resistance may be increased and deterioration of a cell may be promoted.

In the air electrode composite according to an exemplary embodiment, an application area ratio of the electron conductive nanoparticles (sum of sections of the electron conductive nanoparticles/total surface area of the porous structure) may be 5 to 40% based on the total surface area of the porous structure. Specifically, it may be 10 to 40%, 15 to 40%, 20 to 40%, 25 to 40%, or 30 to 40%.

When the application area ratio of the electron conductive nanoparticles is included in the range described above, sufficient oxygen ion conductivity is sufficiently high while improving electron conductivity, and thus, electrode performance may be improved by significantly lowering electrode resistance. However, when the application area ratio of the electron conductive nanoparticles is less than the lower limit of the range described above, electrode conductive area is not sufficiently formed, and thus, discontinuity of an electrode conduction path may occur. Thus, electron movement is not smooth, so that electrode resistance may be increased and a cell performance may be deteriorated. In addition, when the average separation distance between the electron conductive nanoparticles is more than the upper limit of the range described above, agglomeration between electron conductive nanoparticles may occur and gas transport may be inhibited.

In the air electrode composite according to an exemplary embodiment, the content of the electron conductive nanoparticles may be 0.1 to 5 wt % based on the total weight of the porous structure. Specifically, the content of the electron conductive nanoparticles may be 0.2 to 5 wt %, 0.25 to 4 wt %, or 0.5 to 3 wt %.

When the content of the electron conductive nanoparticles is included in the range described above, a connectivity of the electron conductive nanoparticles distributed on the surface of the oxygen ion conductive porous structure may be improved to ensure the facile electron flow. In addition, oxygen ion conductivity and electron conductivity may be balanced to obtain high electrode performance. However, when the content of the electron conductive nanoparticles is less than the lower limit of the range described above, the electron conductive nanoparticles are widely separated, so that overlap and connectivity of the electron conductive area are decreased. Thus, sufficient electron conduction paths are not formed on the interface and surface of the oxygen ion conductive porous structure in contact with the electron conductive nanoparticles, so that electron conductivity may be decreased and electrode performance may be lowered. When the content of the electron conductive nanoparticles is more than the upper limit of the range described above, the electron conductive nanoparticles may be agglomerated or non-uniformly distributed, and rather, polarization resistance or ohmic resistance may be increased to deteriorate the cell performance.

In the air electrode composite according to an exemplary embodiment, the oxygen ion conductive material may include at least one or more selected from gadolinium-doped ceria (GDC), samarium-doped ceria (SDC), yttrium-doped ceria (YDC), and lanthanum-doped ceria (LDC). More specifically, the oxygen ion conductive material may be gadolinium-doped ceria (GDC).

In the air electrode composite according to an exemplary embodiment, the porous structure may not include lanthanum strontium cobalt ferrite (LSCF).

In the air electrode composite according to an exemplary embodiment, the electron conductive nanoparticles may include a metal oxide represented by the following Chemical Formula 1:

ABO_{3±x} [Chemical Formula 1]
wherein A is one or more selected from Sr, Sm, La, Ba, Gd, and Ca, B is one or more selected from Co, Mn, Fe, Ni, Cu, Ti, Nb, Cr, and Sc, and 0≤x≤0.3.

When the electron conductive nanoparticles are metal oxide (ceramic) nanoparticles, they may be stably attached to a surface of the oxygen ion conductive material, and thus, lifespan characteristics of an electrode may be improved. In addition, since the metal oxide (ceramic) electron conductive nanoparticles have higher stability at a high temperature than pure metal nanoparticles, the high temperature characteristics of an electrode may be improved.

In the air electrode composite according to an exemplary embodiment, the electron conductive nanoparticles may include samarium strontium cobaltite (SSC) represented by the following Chemical Formula 2:

(SmₐSr_{b})CoO₃ [Chemical Formula 2]
wherein a+b=1, 0≤a≤1, and 0≤b≤1 are all satisfied.

In the air electrode composite according to an exemplary embodiment, the porous structure may have a thickness of 5 to 40 μm. Specifically, the porous structure may have a thickness of 6 to 35 μm, 7 to 30 μm, 8 to 25 μm, 9 to 20 μm, or 10 to 15 μm.

When the thickness of the porous structure is included in the range described above, the size and the pore size of the oxygen ion conductive material particles forming the porous structure may be appropriate to improve oxygen ion conductivity. However, the thickness of the porous structure is less than the lower limit of the range described above, the amount of the oxygen ion conductive material is not sufficient, so that the conduction of oxygen ions may not be facile. In addition, when the thickness of the porous structure is more than the upper limit of the range described above, the conduction path for the oxygen ions becomes longer and the resistance increases.

Hereinafter, a method of manufacturing an air electrode composite according to another exemplary embodiment will be described.

The method of manufacturing an air electrode composite according to another exemplary embodiment includes: forming a porous structure including an oxygen ion conductive material; preparing a precursor solution in which an electron conductive material precursor, urea, and glycine are mixed; injecting the precursor solution into pores of the porous structure; and heat treating the porous structure into which the precursor solution has been injected, wherein in the heat treating, a heat treatment temperature is in range of 600 to 900° C. Specifically, a heat treatment temperature may be in a range of 600 to 850° C., 600 to 800° C., 600 to 750° C., 600 to 700° C., 620 to 680° C., or 640 to 660° C. More specifically, the heat treatment temperature may be 650° C.

When the heat treatment temperature is included in the range described above, the perovskite crystal structure of the electron conductive nanoparticles is formed well, and the average particle diameter (D50) of the nanoparticles may be controlled to an appropriate level. Thus, uniform electron conductivity may be achieved and electrode performance may be improved. However, the heat treatment temperature is lower than the lower limit of the range described above, the crystal structure of the electron conductive nanoparticles is not formed well, so that electron conductivity is decreased, and the nanoparticles are easily degraded, so that an electrode performance may be deteriorated. In addition, when the heat treatment temperature is more than the upper limit of the range described above, the average particle diameter (D50) of the electron conductive nanoparticles is increased, so that the particles may be agglomerated or non-uniformly distributed. Thus, polarization resistance or ohmic resistance may be increased and cause degradation of a cell.

The forming of a porous structure in the method of manufacturing an air electrode composite according to another exemplary embodiment may include applying the oxygen ion conductive material on one surface of an electrolyte and then sintering it at 1000 to 1400° C. Specifically, a sintering temperature after applying the oxygen ion conductive material may be 1050 to 1350° C., 1100 to 1350° C., 1150 to 1300° C., 1150 to 1250° C., or 1150 to 1200° C. More specifically, it may be 1200° C.

When the sintering temperature is included in the range described above, the pore size of the porous structure and the particle size of the oxygen ion conductive material are formed in an appropriate level, so that oxygen ion conductivity may be sufficiently secured. However, when the sintering temperature is less than the lower limit of the range described above, the oxygen ion conductive material particles forming the porous structure do not sufficiently grow, so that oxygen ion movement may be inhibited, and thus, a decrease in oxygen ion conductivity and deterioration of electrode performance may be caused. In addition, when the sintering temperature is more than the upper limit of the range described above, the particles of the oxygen ion conductive structure excessively grow and density is increased, so that pores are greatly decreased or almost non-existent. Thus, the surface area of the oxygen ion conductive porous structure is decreased, so that the concentration of the electron conductive nanoparticles attached to the surface of the structure may also be decreased. As a result, electron conductivity may be lowered and electrode performance may be lowered.

A method of applying the oxygen ion conductive material may be specifically a screen printing method. However, the present disclosure is not limited thereto.

In the forming of a porous structure in the method of manufacturing an air electrode composite according to another exemplary embodiment, the oxygen ion conductive material may include at least one or more selected from gadolinium-doped ceria (GDC), samarium-doped ceria (SDC), yttrium-doped ceria (YDC), and lanthanum-doped ceria (LDC).

In the preparing of a precursor solution in the method of manufacturing an air electrode composite according to another exemplary embodiment, the electron conductive material precursor includes a metal A nitrate and a metal B nitrate, and the metal A is one or more selected from Sr, Sm, La, Ba, Gd, and Ca and the metal B may include one or more selected from Co, Mn, Fe, Ni, Cu, Ti, Nb, Cr, and Sc.

However, the metal A and the metal B are not limited to the type of metal element described above, and may include those which are extended and applied in addition to the type described above.

In the preparing of a precursor solution in the method of manufacturing an air electrode composite according to another exemplary embodiment, the solvent may be an alcohol aqueous solution and the alcohol may include one or more selected from methanol, ethanol, propanol, and butanol.

However, the alcohol is not limited to the type described above, and may include those which are extended and applied in addition to the type described above.

In the preparing of a precursor solution in the method of manufacturing an air electrode composite according to another exemplary embodiment, the amount of the electron conductive material precursor added may be in a range of 1 to 10 wt %. Specifically, the amount of the electron conductive material precursor added may be in a range of 3 to 10 wt % or 5 to 10 wt %.

When the amount of the electron conductive material precursor added is included in the range described above, connectivity of the electron conductive nanoparticles distributed on the surface of the oxygen ion conductive porous structure may be improved, so that the continuous flow of electron may be achieved. In addition, oxygen ion conductivity and electron conductivity may be in balance to obtain high electrode performance. However, the amount of the electron conductive material precursor added is less than the lower limit of the range described above, the electron conductive nanoparticles are widely separated, so that the overlap and connectivity of the electron conductive area are decreased. Thus, sufficient electron conduction paths are not formed on the interface and surface of the oxygen ion conductive material in contact with the electron conductive nanoparticles, so that electron conductivity may be decreased and electron performance may be lowered. When the amount of the electron conductive material precursor added is more than the upper limit of the range described above, electron conductive nanoparticles may be agglomerated or non-uniformly distributed, and rather, polarization resistance or ohmic resistance may be increased to lower the cell performance.

Hereinafter, an electrochemical cell according to another exemplary embodiment of the present disclosure will be described.

The electrochemical cell according to another exemplary embodiment may include the air electrode composite according to an exemplary embodiment of the present disclosure.

The electrochemical cell according to another exemplary embodiment may be any one of a solid oxide fuel cell or a water electrolysis cell.

Hereinafter, the examples, the comparative examples, and the experimental examples of the present disclosure will be described. However, the following examples are only a preferred example of the present disclosure, and the present disclosure is not limited by the following examples. In addition, various modifications are possible within the scopes of the claims, the detailed description of the disclosure, and the attached drawings, and may also fall within the range of the present disclosure.

### Example 1

### (1) Manufacture of Air Electrode Composite

A Gd_{0.1}Ce_{0.9}O_{1.95} (GDC)-containing solution having an average particle diameter (D50) of 100 nm was applied on a YSZ electrolyte by a screen printing process, and then sintered at a temperature of 1200° C. to form a porous structure. At this time, the porous structure had a thickness of 20 μm.

Thereafter, samarium nitrate, strontium nitrate, cobalt nitrate, urea, and glycine were added to a mixed aqueous solution of water and ethanol to prepare a coating solution.

Thereafter, the coating solution was impregnated (injected) into the pores of the porous structure, and the amount of the electron conductive nanoparticle (SSC) added was 2*10⁻⁶ mol.

Thereafter, the porous structure in which the coating solution was impregnated was heat treated at a temperature of 650° C. to manufacture an air electrode composite on which a (Sm_{0.5}Sr_{0.5})CoO₃ coating layer was formed. At this time, the content of (Sm_{0.5}Sr_{0.5})CoO₃ (SSC) which is an electron conductive material was 0.5 wt % based on the weight of Gd_{0.1}Ce_{0.9}O_{1.95} (GDC) which is an oxygen ion conductive material.

### (2) Manufacture of Solid Oxide Fuel Cell

A Ni—YSZ negative electrode having a thickness of about 400 μm and the positive electrode on a YSZ electrolyte having a thickness of about 5 μm were formed to manufacture a fuel battery.

### Example 2

An air electrode composite and a solid oxide fuel cell were manufactured in the same manner as in Example 1, except that during manufacture of the air electrode composite, the amount of the electron conductive nanoparticles (SSC) injected was 1*10⁻⁶ mol.

At this time, in the manufactured air electrode composite, the content of (Sm_{0.5}Sr_{0.5})CoO₃ (SSC) which is an electron conductive material was 0.25 wt % based on the weight of Gd_{0.1}Ce_{0.9}O_{1.95} (GDC) which is an oxygen ion conductive material.

### Comparative Example 1

An air electrode composite and a solid oxide fuel cell were manufactured in the same manner as in Example 1, except that the air electrode was manufactured using a simple mixture composite of 50 wt % La_{0.6}Sr_{0.4}Co_{0.2}Fe_{0.8}O₃ (LSCF)-50 wt % Gd_{0.1}Ce_{0.9}O_{1.95} (GDC).

### Comparative Example 2

An air electrode composite and a solid oxide fuel cell were manufactured in the same manner as in Example 1, except that during manufacture of the air electrode composite, (Sm_{0.5}Sr_{0.5})CoO₃ (SSC) which is an electron conductive material was formed in a coat form on the surface of a Gd_{0.1}Ce_{0.9}O_{1.95} (GDC) structure which is an oxygen ion conductive material. At this time, the (Sm_{0.5}Sr_{0.5})CoO₃ coat had a thickness of 5 nm.

### Experimental Example 1—Air Electrode Composite Image Analysis

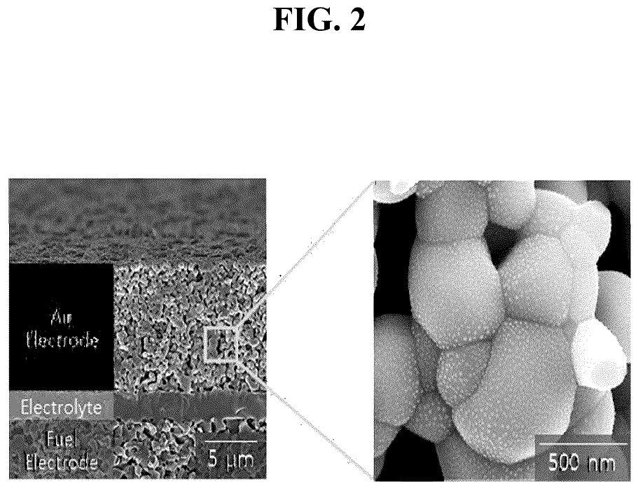

In order to analyze the structure and the form of the air electrode composite manufactured according to the exemplary embodiment of the present disclosure, scanning electron microscope (SEM) and transmission electron microscope (TEM) images were observed, and are shown in FIGS. 2 to 5.

FIG. 2 is an SEM image of an air electrode composite manufactured according to Example 1 of the present disclosure.

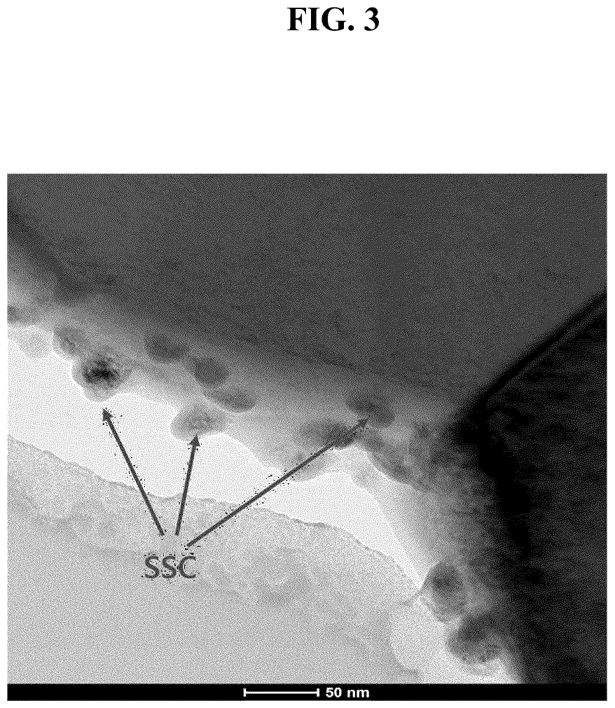

FIG. 3 is a TEM image of the air electrode composite manufactured according to Example 1 of the present disclosure.

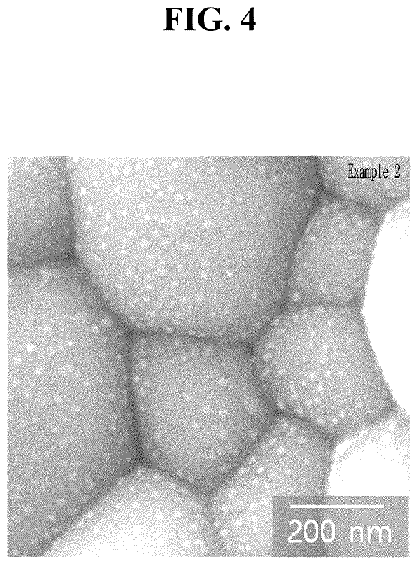

FIG. 4 is an SEM image of an air electrode composite manufactured according to Example 2 of the present disclosure.

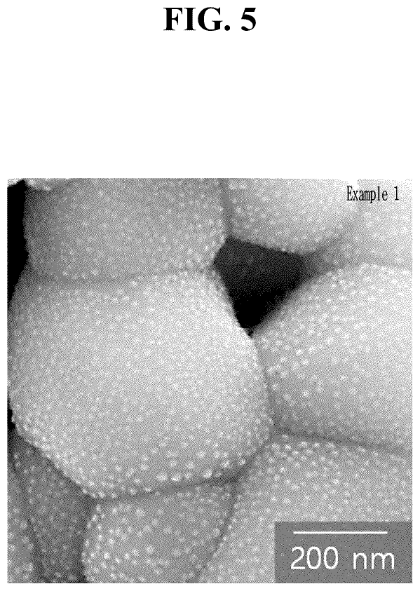

FIG. 5 is an SEM image of an air electrode composite manufactured according to Example 1 of the present disclosure.

Referring to FIG. 2, it is confirmed that the air electrode composite according to Example 1 was formed of a porous structure, and its thickness was about 20 μm. In addition, it is confirmed that electron conductive nanoparticles (SSC) were distributed on the surface of the porous composite.

Referring to FIG. 3, it is confirmed that electron conductive nanoparticles (SSC) having a diameter at a level of about 5 to 10 nm were distributed separately at similar intervals on the surface of the porous air electrode composite.

Referring to FIG. 4, it is confirmed that the air electrode composite according to Example 2 showed a shape in which electron conductive nanoparticles (SSC) were largely uniformly distributed on the surface of the porous structure.

Referring to FIG. 5, it is confirmed that the air electrode composite according to Example 2 showed a shape in which electron conductive nanoparticles (SSC) were largely uniformly distributed on the surface of the porous structure. In addition, upon comparison with Example 2 of FIG. 4, it is confirmed that a separation degree was decreased due to a denser distribution of SSC, but a uniform distribution was maintained without occurrence of agglomeration.

### Experimental Example 2—Evaluation of Electrochemical Characteristics

### (1) Evaluation of Resistance Characteristics

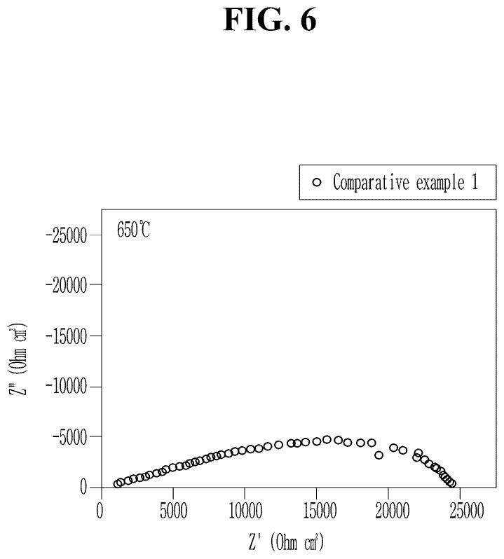

Impedance was measured at 0.1-105 Hz while 200 sccm of hydrogen was supplied to a negative electrode (fuel electrode) and 200 sccm of air was supplied to a positive electrode (air electrode) at 650° C., and resistance characteristics were evaluated, which are shown in FIGS. 6 to 8.

FIG. 6 is an impedance measurement result graph of an air electrode composite manufactured according to Comparative Example 1 of the present disclosure.

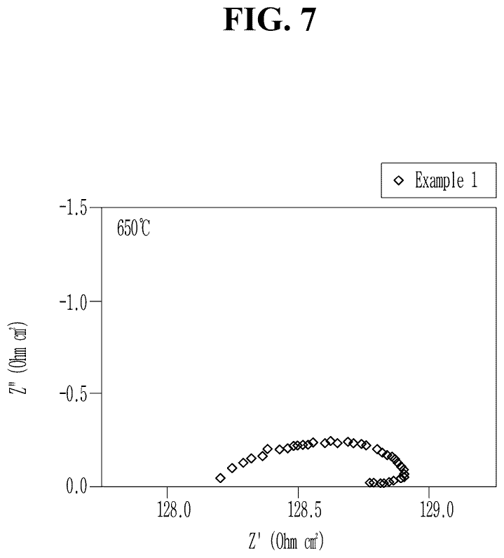

FIG. 7 is an impedance measurement result graph of the air electrode composite manufactured according to Example 1 of the present disclosure.

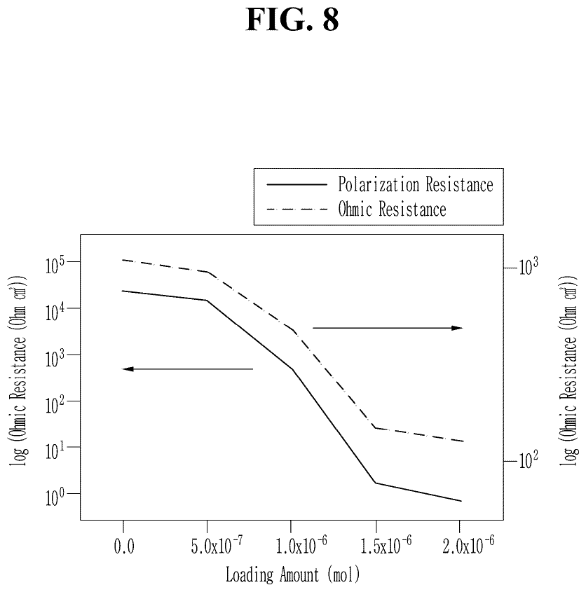

FIG. 8 is an impedance measurement result graph of the air electrode composite depending on injection amounts of electron conductive nanoparticles.

Referring to FIG. 6, it is confirmed that the air electrode composite manufactured according to Comparative Example 1 showed a large polarization resistance of about 25000 Ohm·cm². This means that since the air electrode composite according to Comparative Example 1 had no electron conductivity, it did not operate as an electrode.

Referring to FIG. 7, it is confirmed that the air electrode composite manufactured according to Example 1 showed a significantly small polarization resistance of about 128.7 to 128.9 Ohm·cm². Besides, upon comparison with Comparative Example 1, it is confirmed that significantly low ohmic resistance was shown. That is, it may be understood that electron conductivity was secured by SSC distributed on the surface of the porous structure to significantly decrease resistance.

Referring to FIG. 8, it is confirmed that the air electrode composites of Examples 1 and 2 had significantly low polarization resistance and ohmic resistance, and in particular, the air electrode composite of Example 1 showed a polarization resistance of 1 Ohm·cm² or less, and thus, electrode characteristics were excellent.

### (2) Evaluation of Output Characteristics

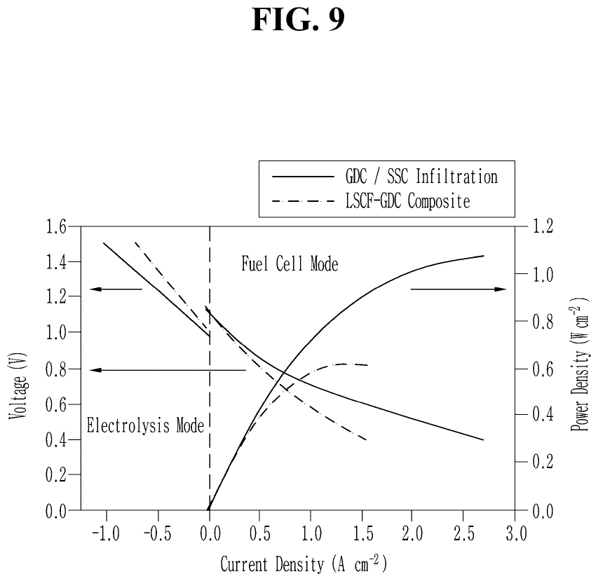

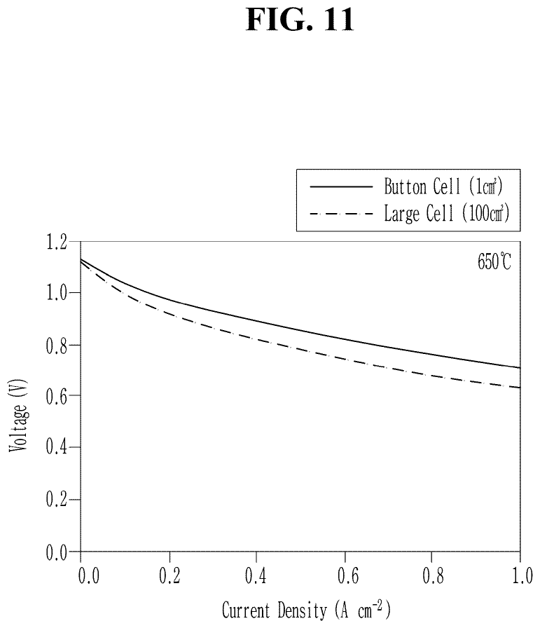

Output characteristics were evaluated by supplying 200 sccm of hydrogen to a negative electrode (fuel electrode) and 200 sccm of air to a positive electrode (air electrode) at 650° C. to measure a current-voltage curve, which is shown in FIGS. 9 and 11.

FIG. 9 is an output characteristic evaluation result graph of solid oxide fuel batteries manufactured according to Example 1 and Comparative Example 1.

FIG. 11 shows output characteristic evaluation results of a button cell (1 cm²) and a large area cell (100 cm²) manufactured according to Example 1.

Referring to FIG. 9, it is confirmed that the fuel battery manufactured according to Example 1 showed better electrochemical performance in both a fuel battery mode and a water electrolysis mode than that of Comparative Example 1. Specifically, it is confirmed that the fuel battery of Example 1 showed high performance of a maximum output of 1.1 W cm⁻² in a fuel battery mode and 0.6 A cm⁻² @ 1.3V in a water electrolysis mode.

Referring to FIG. 11, when a fuel battery to which the air electrode composite according to Example 1 of the present disclosure was applied was manufactured into a button cell having an area of 1 cm² and a large area cell having an area of 100 cm², respectively and compared, it was confirmed that there was no big difference in output characteristics. That is, even when the air electrode composite of the present disclosure had a larger area, performance degradation did not significantly occur, and thus, it is favorable for commercialization.

### (3) Evaluation of Lifespan Characteristics

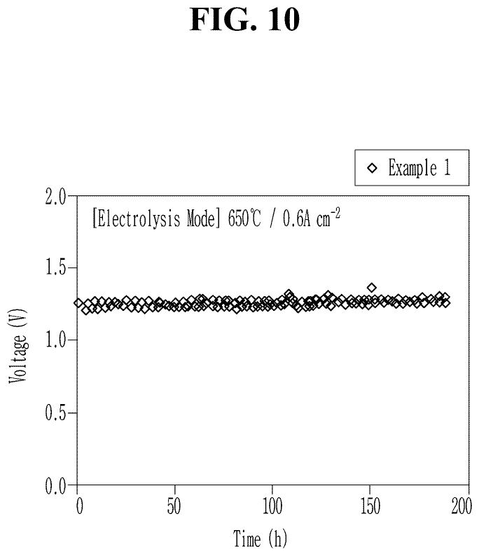

Lifespan characteristics were evaluated by supplying 200 sccm of hydrogen to a negative electrode (fuel electrode) and 200 sccm of air to a positive electrode (air electrode) at 650° C. to measure change in voltage with a current of 0.6 A/cm² applied, which is shown in FIG. 10.

FIG. 10 is a lifespan characteristic evaluation result graph of the solid oxide fuel cell manufactured according to Example 1.

Referring to FIG. 10, when the lifespan characteristics of the fuel battery manufactured according to Example 1 were evaluated for about 200 hours, it was confirmed that the fuel battery stably operated without occurrence of deterioration of the cell.

Hereinabove, the preferred exemplary embodiments of the present disclosure have been described, but the present disclosure is not limited thereto, and may be variously modified within the scope of the claims, the detailed description of the disclosure, and the attached drawing, which also belongs to the scope of the present disclosure, of course.

Accordingly, the substantial right scope of the present disclosure is defined by the appended claims and the equivalents thereto.

### DESCRIPTION OF SYMBOLS

10: air electrode composite
100: oxygen ion conductive porous structure
200: electron conductive nanoparticle
201: electron conductive nanoparticle
202: electron conductive nanoparticle
A201: center of electron conductive nanoparticle
A202: center of electron conductive nanoparticle

What is claimed is:

1. An air electrode composite comprising:
a porous structure including an oxygen ion conductive material; and
electron conductive nanoparticles distributed in an island shape on a surface of the porous structure,
wherein the electron conductive nanoparticles have an average particle diameter (D50) of 5 to 50 nm.

2. The air electrode composite of claim 1, wherein:
an average separation distance between the electron conductive nanoparticles is 5 to 50 nm.

3. The air electrode composite of claim 1, wherein:
an application area ratio of the electron conductive nanoparticles (sum of sections of the electron conductive nanoparticles/total surface area of the porous structure) is 5 to 40% based on the total surface area of the porous structure.

4. The air electrode composite of claim 1, wherein:
a content of the electron conductive nanoparticles is 0.1 to 5 wt % based on the total weight of the porous structure.

5. The air electrode composite of claim 1, wherein:
the oxygen ion conductive material includes at least one or more selected from gadolinium-doped ceria (GDC), samarium-doped ceria (SDC), yttrium-doped ceria (YDC), and lanthanum-doped ceria (LDC).

6. The air electrode composite of claim 1, wherein:
the porous structure does not include lanthanum strontium cobalt ferrite (LSCF).

7. The air electrode composite of claim 1, wherein:
the electron conductive nanoparticles are a metal oxide represented by the following Chemical Formula 1:
ABO_{3±x} [Chemical Formula 1]
wherein A is one or more selected from Sr, Sm, La, Ba, Gd, and Ca, B is one or more selected from Co, Mn, Fe, Ni, Cu, Ti, Nb, Cr, and Sc, and 0≤x≤0.3.

8. The air electrode composite of claim 1, wherein:
the electron conductive nanoparticles are samarium strontium cobaltite (SSC) represented by the following Chemical Formula 2:
(SmₐSr_{b})CoO₃ [Chemical Formula 2]
wherein a+b=1, 0≤a≤1, and 0≤b≤1 are all satisfied.

9. The air electrode composite of claim 1, wherein:
the porous structure has a thickness of 5 to 40 μm.

10. A method of manufacturing an air electrode composite, the method comprising:
forming a porous structure including an oxygen ion conductive material;
preparing a precursor solution in which an electron conductive material precursor, urea, and glycine are mixed;
injecting the precursor solution into pores of the porous structure; and
heat treating the porous structure into which the precursor solution has been injected,
wherein in the heat treating, a heat treatment temperature is in a range of 600 to 900° C.

11. The method of manufacturing an air electrode composite of claim 10, wherein:
the forming of a porous structure
includes applying the oxygen ion conductive material on one surface of an electrolyte and sintering it at 1000 to 1400° C.

12. The method of manufacturing an air electrode composite of claim 10, wherein:
in the forming of a porous structure,
the oxygen ion conductive material includes at least one or more selected from gadolinium-doped ceria (GDC), samarium-doped ceria (SDC), yttrium-doped ceria (YDC), and lanthanum-doped ceria (LDC).

13. The method of manufacturing an air electrode composite of claim 10, wherein:
in the preparing of a precursor solution,
the electron conductive material precursor includes a metal A nitrate and a metal B nitrate,
the metal A is one or more selected from Sr, Sm, La, Ba, Gd, and Ca, and
the metal B is one or more selected from Co, Mn, Fe, Ni, Cu, Ti, Nb, Cr, and Sc.

14. The method of manufacturing an air electrode composite of claim 10, wherein:
in the preparing of a precursor solution,
the solvent is an alcohol aqueous solution, and the alcohol includes one or more selected from methanol, ethanol, propanol, and butanol.

15. The method of manufacturing an air electrode composite of claim 10, wherein:
in the preparing of a precursor solution,
an amount of the electron conductive material precursor added is in a range of 1 to 10 wt % based on the total weight of the porous structure.

16. An electrochemical cell comprising the air electrode composite of any one of claim 1.

17. The electrochemical cell of claim 16, wherein:
the electrochemical cell is any one of a solid oxide fuel cell or a water electrolysis cell.
